(19) United States
(12) Patent Application Publication
(10) Pub. No.: US 2025/0197291 A1
(43) Pub. Date: Jun. 19, 2025

(54) METHOD FOR PRODUCING CERAMIC PARTS AND USE OF THE PARTS OBTAINED BY THIS METHOD

(71) Applicants: UNIVERSITÉ DE LIMOGES, Limoges Cedex (FR); CENTRE NATIONAL DE LA RECHERCHE SCIENTIFIQUE, Paris Cedex 16 (FR); CENTRE NATIONAL D'ETUDES SPATIALES, Paris (FR)

(72) Inventors: Tatiana TABARES MEDINA, Limoges (FR); Nicolas DELHOTE, Feytiat (FR); Pierre-Marie GEFFROY, Limoges (FR); Olivier TANTOT, Limoges (FR); Thierry CHARTIER, Feytiat (FR)

(21) Appl. No.: 18/707,112

(22) PCT Filed: Nov. 2, 2022
(86) PCT No.: PCT/IB2022/060543

§ 371 Date: Oct. 11, 2024

(30) Foreign Application Priority Data
Nov. 5, 2021 (FR) 2111783

(51) Int. Cl. C04B 35/117; C04B 35/626; C04B 35/634; C04B 35/636; C04B 35/638; C04B 35/64

(52) U.S. Cl. CPC C04B 35/117; C04B 35/6261; C04B 35/6263; C04B 35/62655; C04B 35/62695; C04B 35/63416; C04B 35/63444; C04B 35/63488; C04B 35/6365; C04B 35/638; C04B 35/64; C04B 2235/3217; C04B 2235/3232; C04B 2235/5436; C04B 2235/5445; C04B 2235/604; C04B 2235/656; C04B 2235/9607

(57) ABSTRACT

In order to produce a ceramic part from a mixture of two pulverulent mineral materials which differ in terms of their size and which consist of alumina and titanium oxide: (a) a homogenous aqueous suspension of the mixture is prepared, with one or more binders and/or one or more plasticisers which are capable of being pyrolysed by heat during subsequent sintering, the preparation consisting in: (a1) bringing the starting materials into contact with water and at least one deflocculating agent and/or at least one dispersant, and mixing in order to deagglomerate the pulverulent materials; and (a2) adding the binder(s) and/or the plasticiser(s) to the suspension obtained in (a1) until they are homogenised; (b) carrying out cryogenic granulation of the aqueous suspension obtained in (a2), said cryogenic granulation consisting in freezing by spraying followed by lyophilisation in order to obtain lyophilised granules; (c) shaping the granules obtained in (b) by pressing to obtain a preform; then (d) the preform is sintered in order to obtain the desired part.

The present invention concerns the manufacture of ceramic composite parts from a mixture of mineral powders of different sizes and/or densities.

Examples include parts made of alumina-rutile composite material, where the alumina powder has a median particle size (D₅₀) of 0.2 to 0.4 micron and the rutile powder has a median particle size (D₅₀) of 1 to 2 microns.

Such ceramic composite parts can be obtained by synthesizing the powder from a solution with a mixture of precursors. Such a process is very costly.

Such ceramic composite parts can also be obtained by preparing an aqueous suspension of a mixture of starting mineral powders, incorporating at least one binder and/or at least one plasticiser into the aqueous suspension, atomising the resulting aqueous suspension in order to obtain granules, shaping the granules by pressing, and heat-treating the resulting preform, called sintering, in order to consolidate the desired part, the binder(s) and/or and densify plasticiser(s) being pyrolyzed by the sintering.

With this process, which requires the production of large batches of powders due to the atomisation process, we observe significant drift in the chemical composition of composite parts, as well as risks of discharge or pollution due to the fine powder particles produced. This significant drift in composition is linked in particular to granulometric segregation phenomena during the atomisation operation, due to the different sizes of the starting powders.

Current processes either are very expensive to guarantee precise, controlled chemical composition of composite parts, without pollution, or are unsuitable for precise control of the chemical composition of composite parts.

Until now, industrial needs have been met by integrating chemical composition drifts during the process into the starting composition.

This approach requires a posteriori knowledge of process drift, which is very difficult to determine with any degree of precision.

La Lumia et al. “Fabrication of homogenous pellets by freeze granulation of optimized TiO₂—Y₂O₃ suspensions” Journal of European Ceramic Society vol. 39, No 6, 2019 and patent application WO 2019/038497 A1 describe a process for manufacturing homogeneous pellets for nuclear applications. Marco D et al. Dielectric properties of alumina doped with TiO₂ from 13 to 73 Ghz” Journal of European Ceramic Society, vol 37, No 2, 2016, Miyauchi et al. “Improvement of the dielectric properties of rutile doped Al₂O₃ ceramics by annealing society” Journal of European Ceramic Society, vol. 26, No 10-11, 2006 and HUANG CHENG-LIANG ET AL: “Microwave Dielectric Properties of Sintered Alumina Using Nano-Scaled Powders of alpha-Alumina and TiO₂”, Journal of the American Ceramic Society, vol 90, no 5, May 2007, pp 1487-1493 describe conventional processes for preparing mixtures of alumina and titanium oxide that can lead to heterogeneities in the powder mixture and, above all, to pollution.

Parts made of ceramic composite material according to the present invention are intended in particular to constitute:
substrates, such as plates, for microwave components formed by metal tracks arranged on these substrates;
microwave components formed from ceramic blocks machined to the required geometry; and
supports or spacers between substrates and dielectric resonators.

The areas identified include microwave telecommunications for communications satellites, civil and military ground and airborne radars, microwave components for civil telecommunications such as 4G, 5G and post-5G networks, and PMR (Professional Mobile Radio) networks on free and licensed frequency bands.

For such ceramic parts, low porosity, low pollution and good phase homogeneity are necessary to obtain the desired properties.

The aim of the present invention is therefore to make it possible to manufacture composite ceramic parts from ceramic base powders that are highly sensitive to changes in their properties due to possible chemical or compositional contamination of the material during production.

For this purpose, it is proposed, according to the present invention, to treat an aqueous suspension of a mixture of starting powders with the binder(s) and/or plasticiser(s) by cryogenic granulation, making the process easy to implement and enabling control of the chemical composition of the material during its production by limiting the risks of pollution or drift of the chemical composition.

Unlike atomisation, cryogenic granulation is easy to implement, fast and reproducible, avoiding the need to manufacture large batches of powder, which is a source of the drifts described above, and leading to the desired properties: high density, closed porosity, dielectric properties.

More specifically, we were able to obtain good homogeneity of the starting powders within the granules, limiting the migration of smaller particles, a wide distribution of granule sizes, good compactability and excellent natural sinterability.

The first object of the present invention is therefore a method for producing a ceramic part from a mixture of two pulverulent mineral materials which differ in terms of their size and which consist of alumina and titanium oxide, characterized in that:
(a) a homogeneous aqueous suspension of the mixture of the starting pulverulent mineral materials is prepared with one or more binders and/or one or more plasticisers which are capable of being pyrolyzed by heat during subsequent sintering, the preparation consisting in:
   (a1) bringing the starting pulverulent mineral materials into contact with water and at least one deflocculating agent and/or at least one dispersant, and mixing in order to deagglomerate the pulverulent mineral materials until a homogeneous aqueous suspension is obtained; then
   (a2) adding the binder(s) and/or the plasticiser(s) to the suspension obtained in (a1) until they are homogenised;
(b) carrying out cryogenic granulation of the suspension obtained in (a2), said cryogenic granulation consisting in freezing by spraying followed by lyophilisation in order to obtain lyophilised granules;
(c) shaping the granules obtained in (b) by pressing to obtain a preform; then
(d) the preform is sintered in order to obtain the desired part.

The starting pulverulent mineral materials can be chosen from those with median particle sizes (D₅₀) of between 0.1 and 10 microns and densities of between 1 and 7 g/ml.

By way of example, the starting alumina may have a median particle size (D₅₀) of 0.2 to 0.4 μm and the starting titanium oxide introduced in particular in its rutile form, may have a median particle size (D₅₀) of 1 to 1.6 μm.

In step (a1), the mixture of pulverulent mineral materials may be present at a content of 5 to 30% by volume relative to the volume of water in the suspension.

In step (a1), at least one dispersant can be used which represents, on a dry basis, 0.2 to 0.5% by weight of the mixture of the starting pulverulent mineral materials.

In step (a1), a 1% by weight aqueous solution of poly(ammonium methacrylate) can be used as the dispersant.

In step (a2), the binder can be chosen from the main binders used in aqueous media, such as polyvinyl alcohol (PVA), latex emulsions and cellulose binders such as carboxymethylcellulose (CMC).

In step (a2), the plasticiser can be chosen from glycols, being for example polyethylene glycol.

The quantity by weight of binder(s) and/or plasticiser(s) may represent 1 to 5% by weight of the powder in the suspension.

In step (a1), the mixing can be carried out using a 3D dynamic mixer using beads with a diameter of 2 mm and three times the volume fraction of the powder, with mixing taking a few hours.

In step (b), the suspension obtained in step (a2) is advantageously pumped to an injection nozzle in a cryogenic enclosure in order to ensure pulverization of the suspension in said cryogenic enclosure, in order to obtain compact spherical granules with a size distribution advantageously between 10 μm and 1 mm.

In step (c), the granules can be uniaxially or isostatically pressed at a pressure of between 30 and 200 MPa.

In step (d), the sintering can be carried out at a temperature of between 1300° C. and 1500° C.

The process according to the present invention can lead to a ceramic part in the form in particular of a block, machinable block, strip, cuttable strip having at least one of the following properties:
a relative permittivity (εᵣ) in the range of 9 to 15;
a dielectric loss expressed by the loss angle defined by tan δ between 2×10⁻⁵ and 10×10⁻⁵ in microwave frequency bands;
a linear temperature stability coefficient (τf) between −60 ppm/° C. and +20 ppm/° C.; and
a density of at least 98% of the theoretical density, in particular at least 99% of the theoretical density.

The relative permittivity (εᵣ) is determined by extracting the complex permittivity of a dielectric resonator in a cylindrical cavity.

The dielectric loss expressed by the loss angle defined by tan δ is as determined by extracting the complex permittivity of a dielectric resonator in a cylindrical cavity.

The linear temperature stability coefficient (τf) is determined by measuring the resonant frequency of a dielectric resonator in a cylindrical cavity as a function of temperature in a climatic chamber.

Another object of the present invention is the use of the ceramic part obtained by the method as defined above as a constituent of all or part of microwave components or systems using ceramics in the telecommunications sector, these components being able to:
provide a radiating function, which is the case for narrowband, broadband and ultra-broadband antennas, lenses, antenna diopters antennas based on dielectric resonators;
be used to propagate an electromagnetic field by damped traveling waves, within guides, dividers, combiners or couplers;
serve as a function based on standing waves, which is the case for resonators, oscillators, filters and multiplexers;
as substrates for planar or hybrid microwave circuits; or
act as separators between parts of the microwave component or system that see all or part of the electromagnetic field.

The following Examples illustrate the present invention without, however, limiting its scope.

### EXAMPLE 1

Preparation of a Composite of Alumina (Al₂O₃) Doped with Titanium Dioxide (TiO₂) in the Rutile Phase for the Manufacture of a High-Frequency Filter

### Step (a)

### (a1) Preparation of an Aqueous Suspension of Alumina and Rutile Powders

0.2 g of an aqueous solution of poly(ammonium methacrylate), marketed by Vanderbilt Minerals, LLC as DARVAN® C-N, was placed in a plastic container containing approx. 119 g of 2 mm-diameter alumina beads.

The container was then filled successively with:
−159 ml demineralized water; and
40 g of a mixture of 34 g of alumina powder and 6 g of titanium dioxide powder in rutile phase.

The alumina powder is an alumina powder marketed by Taimei with a median particle size (D₅₀) of 0.2 μm.

The rutile powder is a rutile powder with a median particle size (D₅₀) of 1.6 μm.

The resulting suspension was mixed for 3 hours using a Turbula® Type T2C three-dimensional agitator (Willy A. Bachofen A.G., Switzerland), which deagglomerated the alumina and rutile powders and ensured their homogeneous mixing.

(a2) Homogeneous Mixing of the Suspension from Step (a1) with a Binder and a Plasticiser

Once mixing was complete, the alumina beads were removed from the container and a mixture of:
1 g polyvinyl alcohol (PVA) binder; and
0.5 g polyethylene glycol (PEG) plasticiser, molecular weight 400 g/mol,
was added to the mixture obtained at step (a1).

The resulting suspension was rotated on a roller agitator for at least 3 hours at a speed of 35 rpm, homogenizing the suspension and integrating the plasticiser until a fluid suspension was obtained.

Stage (b): Cryogenic Granulation of the Fluid Suspension from Stage (a2)

### Cryogenic Granulator Used

This device enables a freezing by spraying to be quickly followed by lyophilisation of the frozen granules, during which the granules are dried by sublimation of the ice they contain, without altering their sphericity. The device comprises:
a container designed to hold the suspension to be granulated and to be positioned on a magnetic stirrer to keep the suspension stirred during the operation;
an enclosure suitable for containing liquid nitrogen;
a compressed-air spray nozzle, mounted at the top of the enclosure and suitable for spraying the suspension to be granulated into the liquid nitrogen, where the suspension droplets are instantly frozen into granules;
a peristaltic pump to transport the suspension from the container to the spray nozzle;
a system for regulating the pressure of the air arriving at the spray nozzle;
a device for recovering frozen granules; and
a lyophiliser for frozen granules recovered in this way.

The suspension was injected at a peristaltic pump-controlled speed of 33 ml/min and a specific air pressure of 0.2 bar.

A lyophilisation operation took at least 6 hours for the volume of suspension obtained in this example, during which a stable vacuum of 10⁻³ mbar and a temperature of around −100° C. were ensured.

The granules obtained during cryogenic granulation have good sphericity and a homogeneous distribution of alumina and titanium particles.

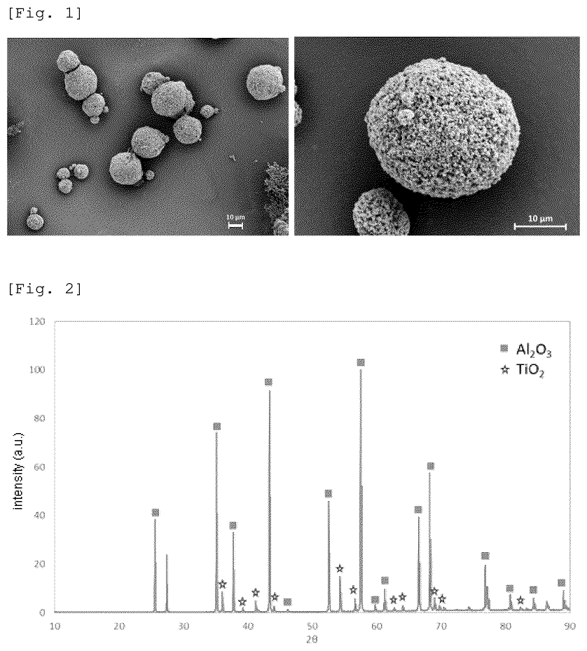

FIG. 1 is a scanning electron microscopy image of the granules after recovery from the lyophiliser.

FIG. 1 shows two spherical granules with sizes of 10 and 25 microns, ideal for good granule flow for homogeneous filling of the pressing die.

### Step (c): Shaping

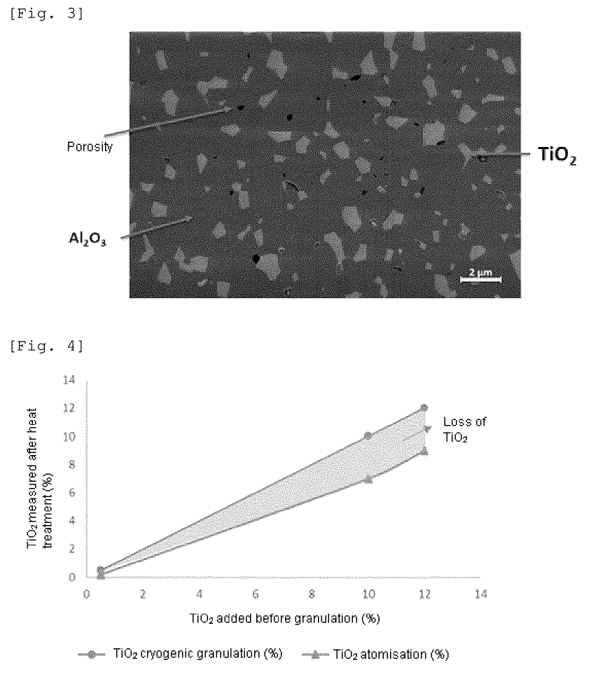

The powder, compressed into pellets, was subjected to a sintering heat treatment at 1400° C. The sintered pellets obtained show good phase homogeneity (see FIGS. 2 and 3), low pollution rate, a relative density of 99%, corresponding to a closed porosity of 1% (determined by image analysis from a of the material) with dielectric properties: εᵣ of 13 and tan δ of 6×10⁻⁵ at 10 GHz and a linear temperature stability coefficient value of 20 ppm/° C.

FIG. 2 shows an X-ray diffraction (XRD) analysis of the phases present in the Al₂O₃—TiO₂ composite after heat treatment.

This figure shows the presence of the phases corresponding to alumina and rutile. In addition, no secondary phases are observed.

FIG. 3 is a micrograph obtained by scanning electron microscopy of the Al₂O₃—TiO₂ composite after heat treatment.

This micrograph shows a dense composite, with a very low porosity rate (in black) of less than 2%. This porosity rate was measured by image analysis on micrographs of the composite. The micrograph also shows the presence of alumina (in dark gray) and rutile grains (in light gray) perfectly dispersed in the alumina matrix. Rutile distribution can be seen mainly in the alumina grain boundaries.

### EXAMPLE 2

This example illustrates the advantages of using the cryogenic granulation process of the invention over the conventional spray granulation process. The composite manufacturing process of Example 1 has been compared with the spray granulation process used for a mixture of Al₂O₃ and TiO₂ powders.

Three compositions with 0.5, 10 and 12% TiO₂ were produced by the granulation method of Example 1 and by atomisation.

For each composition, 150 g of the mixture is introduced into a plastic jar with 300 g of 0.8 mm YTZ beads, the same dispersant as used in Example 1 and osmosis water. These components are mixed in an attritor mill at 800 rpm for 30 min.

Once mixing is complete, the YTZ beads are removed from the jar and the same binder-plasticiser mixture is added to the suspension in the same ratio as used in Example 1.

The resulting suspension is rotated by means of a roller agitator at a speed of 35 rpm, to homogenize the suspension and integrate the binder and plasticiser. Agitation is maintained for at least 3 hours until a fluid suspension is obtained.

Each resulting suspension was atomised in a Büchi Mini Spray Dryer B-290. Atomisation conditions were set at 80% suction, 170° C. inlet temperature, 10% pumping and an air flow rate of around 40 ml/min.

This powder then underwent pressing and sintering steps similar to those described in Example 1.

Table 1 shows the compositions achieved by each granulation method, as well as the amount of TiO₂ measured before and after granulation.

TABLE 1

| | TiO₂ before | TiO₂ after granulation (%) | |
|---|---|---|---|
| | granulation | Cryogenic | |
| Powders | (%) | granulation | Atomisation |
| Al₂O₃ + 0.5% TiO₂ | 0.5 | 0.5 | 0.2 |
| Al₂O₃ + 10% TiO₂ | 10 | 10 | 7 |
| Al₂O₃ + 12% TiO₂ | 12 | 12 | 9 |

FIG. 4 shows the variation in the amount of TiO₂ observed after sintering, depending on the granulation method.

A reduction in the percentage of TiO₂ of around 3% was observed in composites that had been granulated by atmoisation. In addition, the dielectric properties of samples granulated by cryogenic granulation outperform those of samples granulated by atomisation (tan δ of 10⁻⁵ and tan δ of 10⁻⁴ respectively).

1. A method for producing a ceramic part from a mixture of two pulverulent mineral materials which differ in terms of their size and which consist of alumina and titanium oxide, wherein:
(a) a homogeneous aqueous suspension of the mixture of the starting pulverulent mineral materials is prepared with at least one among binders and plasticisers which are capable of being pyrolyzed by heat during subsequent sintering, the preparation consisting in:
(a1) bringing the starting pulverulent mineral materials into contact with water and at least one among deflocculating agents and dispersants, and mixing in order to deagglomerate the pulverulent mineral materials until a homogeneous aqueous suspension is obtained; then
(a2) adding the at least one among binders and plasticizers to the suspension obtained in (a1) until they are homogenised;
(b) carrying out cryogenic granulation of the suspension obtained in (a2), said cryogenic granulation consisting in freezing by spraying followed by lyophilisation in order to obtain lyophilised granules;
(c) shaping the granules obtained in (b) by pressing to obtain a preform; then
(d) the preform is sintered in order to obtain the desired part.

2. The method according to claim 1, wherein the starting alumina has a median particle size (D₅₀) of 0.2 to 0.4 μm and the starting titanium oxide introduced in particular in its rutile form, has a median particle size (D₅₀) of 1 to 1.6 μm.

3. The method according to claim 1, wherein in step (a1), the mixture of pulverulent mineral materials is present in a content of 5 to 30% by volume, based on the volume of water in the suspension.

4. The method according to claim 1, wherein in step (a1) at least one dispersant is used which represents, on a dry basis, 0.2 to 0.5% by weight of the mixture of the starting pulverulent mineral materials.

5. The method according to claim 1, wherein step (a1), a 1% by weight aqueous solution of poly(ammonium methacrylate) is used as the dispersant.

6. The method according to claim 1, wherein step (a2), the binder is selected among polyvinyl alcohol (PVA), latex emulsions, cellulose binders.

7. The method according to claim 1, wherein in step (a2), the plasticiser is selected from glycols.

8. The method according to claim 1, wherein the quantity by weight of at least one among binders and plasticisers represents 1 to 5% by weight of the powder in the suspension.

9. The method according to claim 1, wherein in step (a1), the mixing is carried out with the aid of a 3D dynamic mixer using beads which have a diameter of 2 mm and are three times the volume fraction of the powder, mixing taking a few hours.

10. The method according to claim 1, wherein in step (b), the suspension obtained in step (a2) is pumped to an injection nozzle in a cryogenic enclosure in order to ensure pulverization of the suspension in said cryogenic enclosure, in order to obtain compact spherical granules with a size distribution advantageously between 10 μm and 1 mm.

11. The method according to claim 1, wherein in step (c), an uniaxial or isostatic pressing of the granules is carried out at a pressure of between 30 and 200 MPa.

12. The method according to claim 1, wherein in step (d), the sintering is carried out at a temperature of between 1300° C. and 1500° C.

13. The method according to claim 1, wherein it leads to a ceramic part in the form selected among blocks, machinable blocks, strips, cuttable strips, having at least one of the following properties:
a relative permittivity (εᵣ) in the range of 9 to 15;
a dielectric loss expressed by the loss angle defined by tan δ between 2×10⁻⁵ and 10×10⁻⁵ in microwave frequency bands;
a linear temperature stability coefficient (τf) between-60 ppm/° C. and +20 ppm/° C.; and
a density of at least 98% of the theoretical density.

14. The method according to claim 1 as a constituent of at least a part of microwave components and systems using ceramics in the telecommunications sector, it being possible for these components to:
provide a radiating function, which is the case for narrowband, broadband and ultra-broadband antennas, lenses, antenna diopters and antennas based on dielectric resonators;
be used to propagate an electromagnetic field by damped traveling waves, within guides, dividers, combiners or couplers;
serve as a function based on standing waves, which is the case for resonators, oscillators, filters and multiplexers;
as substrates for planar or hybrid microwave circuits; or
act as separators between parts of the microwave component or system that see all or part of the electromagnetic field.

15. The method according to claim 6, wherein cellulose binder is a carboxymethyl cellulose (CMC).

16. The method according to claim 8, wherein the glycol is polyethylene glycol.

17. The method according to claim 13, wherein the density is of at least 99% of the theoretical density.
